(19) United States
(12) Patent Application Publication
(10) Pub. No.: US 2010/0246040 A1
(43) Pub. Date: Sep. 30, 2010

(54) REAR VISION MIRROR FOR VEHICLE

(75) Inventor: Cheol Seok Lee, Seoul (KR)

Correspondence Address: Jae Y. Park, Kile, Goekjian, Reed & McManus, PLLC, 1200 New Hampshire Ave. NW, Suite 570, Washington, DC, 20036, US

(73) Assignee: SIRIS-K CORPORATION, Anseong Si, Gyeonggi-do (KR)

(21) Appl. No.: 12/741,539

(22) PCT Filed: Nov. 5, 2008
(86) PCT No.: PCT/KR08/06514

§ 371 Date: May 5, 2010

(30) Foreign Application Priority Data
Nov. 7, 2007 (KR) 10-2007-0113367

(51) Int. Cl. G02B 5/10; G02B 7/182

(52) U.S. Cl. 359/871

(57) ABSTRACT

A rear vision mirror for a vehicle is disclosed, which includes a main body unit and a mirror unit. The main body unit is mounted to the outside or the inside of the vehicle, to support and protect the mirror unit. The mirror unit mounted to a front side of the main body unit displays images of other vehicles and objects existing at left and right rear sides of the vehicle. The mirror unit is sectioned into at least two regions each having different eccentricities and refractivities, thereby constituting an aspheric progressive mirror. The rear vision mirror is capable of preventing dead zones, an image distortion, an incorrect sense of distance, and dazzling.

### TECHNICAL FIELD

The present invention relates to a rear vision mirror for a vehicle, and more particularly to a rear vision mirror for a vehicle, capable of preventing generation of dead zones at a rear side of the vehicle, distortion of an image shown therethrough, an incorrect sense of distance, dazzling and so on, by being configured in the form of an aspheric multifocal mirror.

### BACKGROUND ART

In general vehicles, rear vision mirrors are mounted at the outside of left and right front doors and the inside of the vehicle for a driver to easily check road conditions of left, right and rear sides. According to the mounting positions, the rear vision mirrors are called a room mirror and a side mirror. Using the rear vision mirrors, the driver is able to check directions and speeds of other vehicles running at the bilateral sides and the rear side even while watching the front left and right sides, thereby keeping a safety distance from the other vehicles. Also, the driver is able to safely pass other vehicles ahead or change lanes without disturbing the other vehicles running at the rear side. Such a rear vision mirror for vehicles mainly comprises a main body unit for mounting to the vehicle, and a mirror unit mounted to the main body unit to display images of objects.

For example, in a case where the mirror unit of a room mirror is implemented by a plane mirror which scarcely causes refraction, relatively correct distances and shapes of other vehicles and objects at the rear side can be shown without distortion of images of the vehicles and objects. However, since such a plane mirror has a defect of a narrow range of view, the left and right sides of the vehicle become dead zones the driver cannot check.

The side mirror is mounted at the outside of the doors of front seats, respectively. Therefore, the driver is capable of understanding the road conditions at the left and right sides and the rear side through the mirror units of the side mirrors. The minor unit of the side minor comprises a spherical convex mirror in order to increase the range of view for the driver. Although having a wider range of view than the plane minor, the spherical convex minor is defective in causing distortion of images due to a spherical aberration.

The spherical aberration is generated when an index of refraction is varied from the center to the periphery of a spherical lens or mirror having a single curvature. Accordingly, distortion of images is generated in the spherical lens or mirror, increasing toward the periphery. More specifically, in the spherical lens or mirror, when lights are incident parallel with an optical axis, lights passed through the periphery are focused ahead of focus of lights passed through the center, as shown in FIG. 1. Thus, such a spherical lens or minor forms images at different positions according to the light transmitting positions thereof, thereby causing distortion of the images.

In order to solve the problems in using the plane mirror and the convex mirror, such as the narrow range of view and the image distortion, an auxiliary rear vision mirror may be further mounted to the vehicle. In this case, however, the driver has to adjust the auxiliary rear vision mirror repeatedly in accordance with his or her positions and the driving environment, which will be cumbersome for the driver.

Furthermore, since the rear vision minor for vehicles is a unifocal mirror, the driver would suffer from dazzling by headlights of vehicles behind that are focused directly to his or her eyes, during night driving.

Meanwhile, to improve such problems, a rear-view minor enlarging a visual field by continuously and loosely varying curvature of a mirror surface at a peripheral part has been introduced, as disclosed in JP Patent Publication No. 2006-088954. However, according to this technology, enlargement of the visual field is achieved just by the curvature increase at the peripheral part excluding parts having a normal curvature. Therefore, the enlargement of the visual field is not so satisfactory as expected.

Additionally, in JP Patent Publication No. H07-300045, there is disclosed a mirror for an automobile, in which a minor main unit part comprising a plane minor or a convex mirror having a large curvature forms a slow change mirror unit in at least one corner thereof. The slow change mirror unit comprises an aspheric convex mirror gradually decreasing in a radius of curvature toward vertically outer parts and therefore successively contracting a reflected image toward an end with almost fixed aspect ratio, accordingly reducing distortion of the image and a distance error while enlarging the visual field.

However, in the above disclosed mirror, the whole minor main unit part except the slow change minor unit disposed at the periphery is constituted by the plane minor or the convex minor. That is, enlargement of the visual field can be achieved mainly by the curvature of the slow change mirror unit, and therefore the visual field is enlarged not so much as expected. In addition, although the slow change minor unit, as an aspheric minor, is effective in reducing the image distortion and the distance error caused by the image distortion, the image is gradually decreased and shown far toward the peripheral end owing to the property of the convex mirror. Therefore, compared to the plane minor, the convex minor shows the distance to objects existing at the rear side incorrectly.

### DISCLOSURE

### Technical Problem

Therefore, the present invention has been made in view of the above problems, and it is an object of the present invention to provide a rear vision mirror for a vehicle, capable of minimizing dead zones unseen by a driver during driving and improving problems of distortion of a reflected image, an incorrect sense of distance, and a driver's dazzling.

### Technical Solution

In accordance with an aspect of the present invention, the above and other objects can be accomplished by the provision of a rear vision mirror for a vehicle, including a mirror unit in the form of an aspheric progressive surface mirror sectioned in a horizontal direction into at least three aspheric progressive regions having respectively different refractivities and eccentricities; and a main body unit mounted to a vehicle body, while supporting the mirror unit, wherein the refractivity and eccentricity of the sectioned region of the mirror unit are gradually increased from an inner region toward an outer region in a manner that, more specifically, refractivity of the inner region is gradually increased from the middle thereof toward a border with a middle region until being equalized to that of the middle region, and refractivity of the middle region is gradually increased from the middle thereof toward a border with the outer region until being equalized to that of the outer region.

The inner region may have eccentricity of 0.1˜0.2 and refractivity of OD to the middle thereof with respect to the horizontal direction, the middle region has eccentricity of 0.2˜0.3 and refractivity of +0.25 D to the horizontal middle, and the outer region has eccentricity of 0.4 and refractivity of +0.5 D.

Horizontal widths of the inner, middle and outer regions may be in the ratio of 4:3:3, and the mirror unit is applied to a side mirror of the vehicle.

The inner region and the middle region may be further sectioned each to upper and lower regions, so that the lower inner region has a greater eccentricity than the upper inner region and the lower middle region has a greater refractivity than the upper middle region, and the refractivity of the upper middle region is gradually increased from the middle with respect to a vertical direction to a border with the lower middle region until being equalized to that of the lower middle region. In this case, the lower inner region may have eccentricity of 0.2˜0.3 and refractivity of +0.5 D which is the same as that of the outer region.

Vertical widths of the upper and the lower regions of the inner region and the middle region may be in the ratio of 4:1.

The above-structured mirror unit may be applied to a side mirror mounted at the outside of a front door of the vehicle.

In accordance with another aspect of the present invention, there is provided a rear vision mirror for a vehicle, including a mirror unit in the form of an aspheric progressive surface mirror sectioned in a horizontal direction into at least three aspheric progressive regions having respectively different refractivities and eccentricities; and a main body unit mounted to a vehicle body, while supporting the mirror unit, wherein left and right regions of the mirror unit have greater refractivity and eccentricity than a middle region, and the refractivity of the middle region is gradually increased from the middle toward borders with the left region and the right region until being equalized to those of the left and the right regions.

The middle region may have refractivity of 0.00˜+0.25 D and eccentricity of 0.1˜0.2 while the left and the right regions have refractivity of +0.5 D and eccentricity of 0.3˜0.5

When a driver's seat is disposed on the left in the vehicle, the mirror unit is configured so that widths of the left, the middle and the right regions are in the ratio of 3:12:5 and the right region has a greater eccentricity than the left region. When the driver's seat is disposed on the right, the width ratio is set to 5:12:3 and the left region has a greater eccentricity than the right region.

The above-structured mirror unit may be applied to a room mirror mounted on the front middle part in the vehicle.

### ADVANTAGEOUS EFFECTS

As described above, the rear vision mirror according to the embodiment of the present invention comprises an aspheric progressive mirror which applies respectively different eccentricities and refractivities for each region sectioned by a predetermined width such that the eccentricity and the refractivity gradually increase from an inner region or the center toward an outer region. Accordingly, in comparison with a conventional plane mirror and another conventional minor increasing curvature only at the periphery of a mirror surface, the range of view for a driver can be greatly increased, thereby minimizing dead zones at the rear side of the vehicle. In addition, image distortion and driver's dazzling can also be minimized.

Especially, since the refractivity increases from the inner or central region toward the outer regions among the plurality of sectioned regions, the reflected image can be displayed nearer even through the convex mirror. Therefore, the sense of distance can be improved similar to that of the plane mirror.

Furthermore, according to the rear vision mirror of the embodiment of the present invention, lanes located at left, right and rear lower parts of the vehicle can be correctly displayed through lower regions formed by further sectioning, upward and downward, the inner and central regions of a minor unit constituting a side mirror.

Moreover, in case of a room minor, since the refractivity and the eccentricity of a mirror unit are increased toward the left and right sides from the center, size of the room minor can be reduced compared to conventional room mirrors. As a result, the driver's front view would be less interfered with by the room minor.

### DESCRIPTION OF DRAWINGS

The above and other objects, features and other advantages of the present invention will be more clearly understood from the following detailed description taken in conjunction with the accompanying drawings, in which:

FIG. 1 is a view showing characteristics of a conventional spherical lens;

FIG. 2 is a view showing characteristics of an aspheric lens according to embodiments of the present invention;

FIG. 3 is a perspective view of a rear vision mirror according to a first embodiment of the present invention;

FIG. 4 is a front view of the rear vision mirror shown in FIG. 3;

FIG. 5 is a sectional view of the rear vision mirror of FIG. 3, cut along a line T-T′;

FIG. 6 is a front view of a modified version of the rear vision mirror according to the first embodiment of the present invention;

FIG. 7 is a perspective view of a rear vision mirror according to a second embodiment of the present invention;

FIG. 8 is a front view of the rear vision mirror shown in FIG. 7; and

FIG. 9 is a sectional view of the rear vision mirror of FIG. 7, cut along a line T-T′.

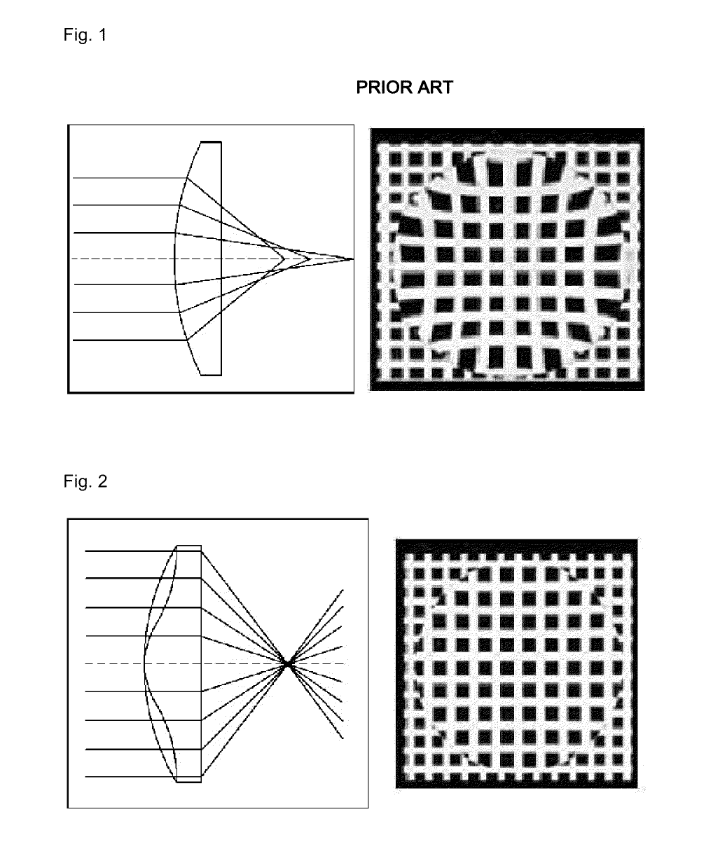

### BEST MODE

Hereinafter, exemplary embodiments of the present invention will be described in detail with reference to the accompanying drawings. In the following description, well-known methods, procedures, and components will not be described in detail so as not to obscure the present invention.

A rear vision minor according to first and second embodiments of the present invention is configured in the form of an aspheric progressive minor.

Here, the aspheric shape refers to a similar shape to a slow normal distribution curve, that is, neither a spherical nor plane shape. On the aspheric surface, curvature may decrease or increase from the center toward the periphery, thereby becoming plane toward the periphery or toward the center. In other words, curvature of the aspheric lens or mirror is varied from the center to the periphery, and degree of such variation can be indicated through eccentricity or an E-value. Shape of the aspheric surface varies depending on the eccentricity. Thus, differently from a spherical shape, the aspheric shape has at least two different curvatures.

FIG. 2 illustrates the aspheric lens to explain characteristics of an aspheric progressive mirror according to the embodiments of the present invention.

Referring to FIG. 2, differently from a spherical lens, the aspheric lens focuses lights being incident to the center and the periphery all to one spot, accordingly reducing a spherical aberration, that is, distortion of an image occurring in the spherical lens. Additionally, since the aspheric lens has respectively different eccentricities according to regions thereof, a range of view of the aspheric lens is wider than that of the conventional spherical lens. As a result, when the aspheric lens is applied to the rear vision mirror of a vehicle, dead zones are not generated at the rear side of the vehicle.

Meanwhile, regarding the progressive mirror, a mirror unit of the rear vision mirror is sectioned into at least two regions to have different refractivities for each region. The refractivity denotes a refraction degree of light passed through the mirror unit, and may be indicated by a diopter (D). For example, the refractivity can be varied by changing the material or thickness of the mirror unit, or changing the curvature of a front or rear surface of the mirror unit. The mirror unit is sectioned into the regions according to the driver's range of view, and the respective regions are applied with different refractivities for the driver to see a short distance and a long distance. Therefore, the driver is able to more correctly see images of other vehicles and objects existing at both a short distance and a long distance. Furthermore, during night driving, headlights from vehicles at the rear side are distributively incident to focuses of the plurality of regions. Accordingly, dazzling generated in a conventional unifocal rear vision mirror can be prevented.

As aforementioned, by comprising the aspheric progressive mirror, the rear vision mirror according to the first and second embodiments of the present invention is capable of preventing generation of dead zones at the rear side of the vehicle, distortion of images, an incorrect sense of distance and a driver's dazzling.

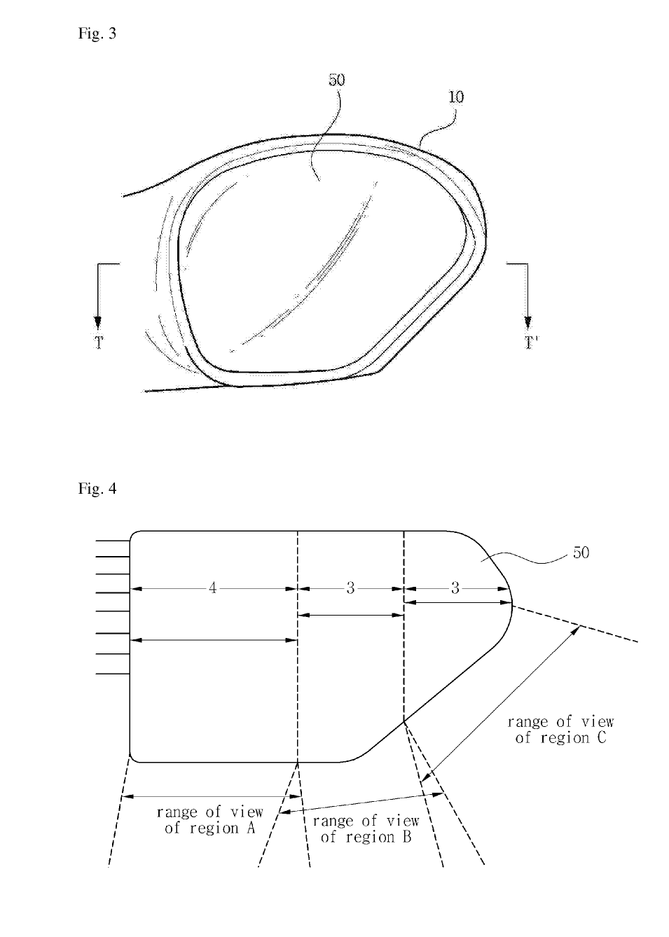

Hereinafter, the rear vision mirror according to the first and second embodiments of the present invention will be described in detail, with reference to FIG. 3 to FIG. 9. In the first embodiment, a side mirror will be explained as an example of the rear vision mirror. In the second embodiment, a room mirror will be explained.

FIG. 3 is a perspective view of the rear vision mirror according to the first embodiment of the present invention, FIG. 4 is a front view of the rear vision mirror of FIG. 3, and FIG. 5 is a sectional view of the rear vision mirror shown in FIG. 3, cut along a line T-T′.

Referring to FIG. 3, the rear vision mirror comprises a main body unit 10 and a mirror unit 50.

The main body unit 10 may be mounted to left and right front doors or integrally formed with the front doors. The mirror unit 50 is mounted to a front side of the main body unit 10. The main body unit 10 not only protects the minor unit 50 from external shocks but also supports the mirror unit 50.

The mirror unit 50 mounted to the front side of the main body unit 10 displays images of vehicles and objects existing at left and right rear sides of the vehicle having the minor unit 50. As shown in FIG. 4 and FIG. 5, the mirror unit 50 according to the first embodiment may be sectioned into three regions, that is, regions A, B and C. A width ratio of the regions may be variable but, according to this embodiment exemplarily, widths of the regions A, B and C are in the ratio of 4:3:3 with respect to a horizontal direction.

Accordingly, the region A occupies the greatest area and the regions B and C occupy the same width area. However, such a width ratio may be differently set depending on the shape of the rear vision mirror. The regions A to C are applied with all different eccentricities and refractivities, each constituting the aspheric progressive mirror. According to the exemplary embodiment of the present invention, the eccentricity and the refractivity are gradually increased from the region A to the region C.

More specifically, the mirror unit 50 comprises three aspheric progressive surface regions having respectively different eccentricities and refracitivities which are increased from an inner region toward an outer region, while constituting the aspheric progressive minor as a whole, so that all the objects at short, middle and long distances can be displayed clearly and undistortedly with one minor.

In a case where the eccentricities of the regions A to C are identical, the whole minor unit 50 can constitute one aspheric shape. However, in this case, it is difficult to display images of the objects existing at short, middle and long distances correctly, that is, without the image distortion or a distance error.

To be more specific, the region A is allocated to an innermost position which is near a vehicle body, to have eccentricity of 0.00 D and refractivity of 0.1˜0.2. Therefore, the region A, although having a wider range of view than a plane mirror by the eccentricity, is capable of displaying images of objects at a near distance as undistortedly as the plane mirror since the eccentricity of the region A is very small.

The region A has smaller eccentricity and refractivity than the region B. In order to prevent image jump from occurring at a border between the regions A and B, the refractivity of a part of the region A is gradually increased, that is, from the middle with respect to a horizontal direction to the border with the region B until being equalized to the refractivity of the region B.

In the region B disposed in the middle of the regions A to C, eccentricity of +0.25 D and refractivity of 0.2˜0.3 are applied. Accordingly, since being an aspheric progressive mirror having a wider range of view and a greater refractivity than the region A, the region B is capable of displaying the images of other vehicles and objects existing in the middle of the left and right rear sides more correctly, almost without the image distortion. Also, since the region B has smaller eccentricity and refractivity than the region C, the refractivity of a part of the region B, that is, from the horizontal middle to the border with the region C is gradually increased until being equalized to the refractivity of the region C, so as to prevent the image jump at a border between the regions B and C.

The region C is disposed at the outermost position of the mirror unit 50, which is the farthest from the vehicle body. Among the three regions A to C, the region C is applied with the greatest eccentricity and refractivity, that is, eccentricity of +0.5 D and refractivity of at least 0.4. Therefore, the region C has the widest range of view out of the three regions A to C, and displays images of other vehicles and objects existing around the vehicle and at dead zones of the conventional rear vision mirror.

Since the region C is an aspheric progressive mirror having a greater refractivity than the region B, the region C is capable of displaying the images without distortion and as near as possible, thereby achieving an optimum sense of distance similar to that of the plane mirror. In addition, since refracting surfaces are formed on the mirror unit 50 according to variation of the refractivities, the headlights from vehicles behind can be distributed to the respective refracting surfaces, thereby reducing the driver's dazzling during the night driving.

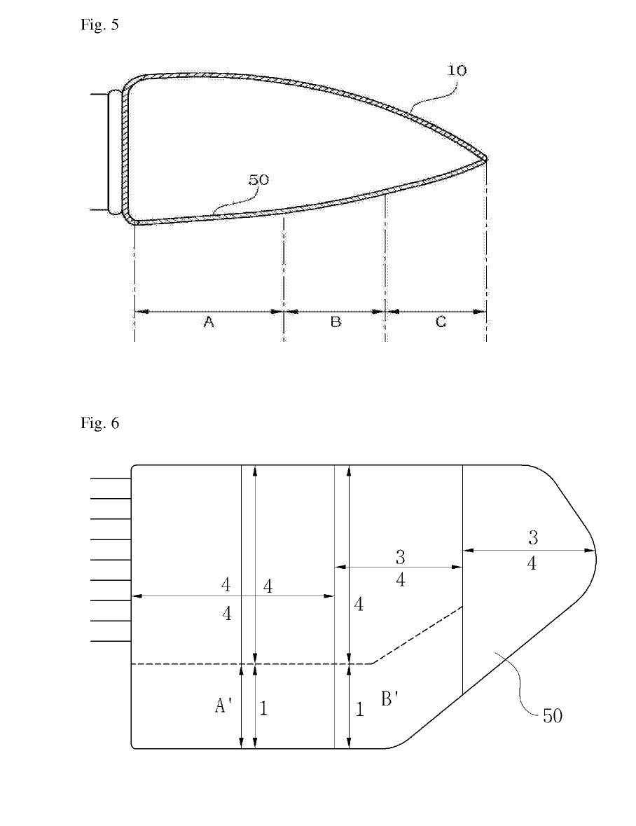

A modified version of the rear vision mirror according to the first embodiment of the present invention is shown in FIG. 6, comprising five regions each having different eccentricities and refractivities.

Referring to FIG. 6, more specifically, the rear vision mirror comprises a region A, a region A′, a region B, a region B′ and a region C. The regions A, B and C are the same as those explained above, and therefore will not be described again.

The region A′ is disposed at a lower end of the region A, so that widths of the region A and the region A′ with respect to a vertical direction are in the ratio of 4:1. The region A′, as an aspheric surface, has eccentricity of 0.2˜0.3 that is greater than that of the region A and equal to that of the region B, but has the same refractivity as the region A, that is, 0.00 D. The above configured region A′ correctly displays lanes existing at a lower part of the vehicle.

The region B′ is disposed at a lower end of the region B, so that widths of the region B and the region B′ with respect to a vertical direction are in the ratio of 4:1. The region B′, as an aspheric surface, has the same eccentricity as the region A′, but has refractivity of +0.50 D which is greater than that of the region B and equal to that of the region C. In order to prevent the image jump from occurring at a border between the regions A′ and B′, the refractivity may be gradually increased from the middle of the region A′ with respect to the vertical direction to the border between the regions A′ and B′ until being equalized to the refractivity of the region B. The above configured region B′ correctly displays lanes existing at a rear lower part of the vehicle.

Accordingly, the driver is able to see the lanes existing at the left and right lower parts through the region A′ and the region B′ and therefore park the vehicle more conveniently.

Distances from the driver to the side mirrors mounted to both sides of the vehicle body are varied according to position of a driver's seat. The distances determine the range of view of the driver watching the side mirrors. As a result, the side mirrors may have different eccentricities and refractivities depending on the driver's range of view.

In the mirror unit 50 of the rear vision mirror according to the first embodiment, having the aspheric progressive surface, the refractivity and the eccentricity are respectively different according to the predetermined regions and increasing toward the outer side. Therefore, as well as solving the dead zones that used to be generated at the rear side of the vehicle and distortion of the images of the other vehicles and objects existing at the left and right rear sides, the sense of distance can be enhanced by displaying the images as near as possible as in the plane minor.

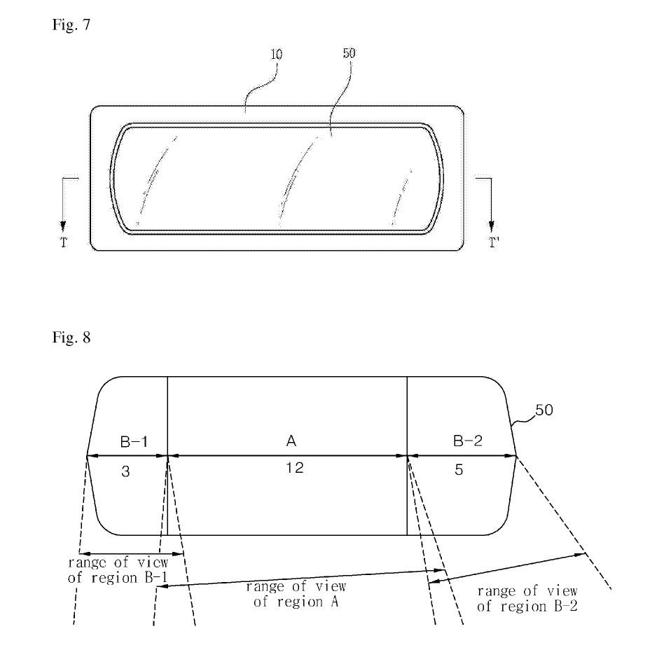

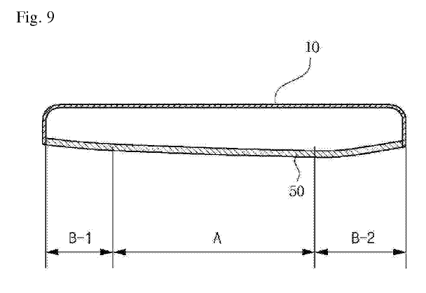

FIG. 7 is a perspective view of a rear vision mirror according to the second embodiment of the present invention. FIG. 8 is a front view of the rear vision mirror shown in FIG. 7, and FIG. 9 is a sectional view of the rear vision mirror of FIG. 7, cut along a line T-T′.

Referring to FIG. 7, the rear vision mirror according to the second embodiment comprises a main body unit 10 and a mirror unit 50.

The main body unit 10 is usually mounted at a border between a front window glass and a ceiling in the vehicle. The mirror unit 50 is mounted on a front side of the main body unit 10. The main body unit 10 supports the minor unit 50 and protects the minor unit 50 from external shocks. When a connection structure is provided to the main body unit 10, the rear vision minor can be detachably mounted to the inner ceiling of the vehicle and also be mounted to any position other than the ceiling as far as enabling the driver to see the rear side.

The mirror unit 50 displays other vehicles and objects existing at the rear side of the vehicle, being in the form of an aspheric progressive mirror. As shown in FIG. 8 and FIG. 9, the minor unit 50 of the second embodiment is sectioned into three regions A, B-1 and B-2. The region A is disposed in the middle of the mirror unit 50 while the regions B-1 and B-2 are disposed on the left and the right of the region A, respectively. Horizontal widths of the regions A, B-1 and B-2 may be in the ratio of 3:12:5.

If the rear vision mirror has a rectangular shape, the width ratio is almost the same as an area ratio among the respective regions. That is, the region A occupies 60% of the whole area of the mirror unit 50, the region B-1 occupies 15% and the region B-2 occupies 25%. In this case, it is preferred that the driver's seat is disposed on the left in the vehicle. If the driver's seat is disposed on the right, the areas ratio between the region B-1 and the region B-2 would be the opposite.

According to the exemplary embodiment, the regions A, B-1 and B-2 are applied with all different eccentricities and refractivities, each constituting the aspheric progressive minor. The regions B-1 and B-2 disposed on the left and the right have greater eccentricity and refractivity than the region A disposed in the middle.

More specifically, the mirror unit 50 comprises three aspheric progressive surface regions having respectively different eccentricities and refracitivities which are increased from the middle part toward the left and right outer sides, while constituting the aspheric progressive mirror as a whole, so that all the objects at short, middle and long distances can be displayed clearly and undistortedly with one mirror.

In a case where the eccentricities of the three regions A, B-1 and B-2 are identical, the whole minor unit 50 can constitute one aspheric shape. However, such a structure is less efficient to correctly display the images than the structure in which each of the regions forms an aspheric progressive surface.

The region A is applied with refractivity of 0.00 D˜+0.25 D and eccentricity of 0.1˜0.2. By thus having proper refractivity and eccentricity, the region A has a wider range of view than the plane minor, thereby being capable of displaying the images more clearly by more correct sense of distance.

Considering that the image jump may happen at borders between the regions A and B-1 and between the regions A and B-2 due to the refractivity difference of the region A from the regions B-1 and B-2, the refractivity of the region A may be gradually increased from the middle part thereof toward the borders with the region B-1 and the region B-2 at the left and the right.

The regions B-1 and B-2 are disposed on the left and the right of the region A, having refractivity of +0.50 D and eccentricity of 0.3˜0.5 which are greater than those of the region A. Accordingly, although having wider ranges of view than the region A, the regions B-1 and B-2 as aspheric progressive mirrors having greater refractivities than the region A are capable of displaying the images of other vehicles and objects existing at the left and right rear sides without causing the image distortion and the distance error.

In addition, the regions B-1 and the region B-2 may have different sizes in accordance with the position of the driver's seat. More specifically, when the driver's seat is disposed on the left in the vehicle so that a distance from the driver to the region B-1 is shorter than a distance to the region B-2, the region B-1 has a wider range of view than the region B-2. Accordingly, it is preferred that the region B-2 has greater area, refractivity and eccentricity than the region B-1. Thus, the area, refractivity and eccentricity of the regions B-1 and B-2 may be set differently in accordance with the position of the driver's seat. In a case where the distances from the driver to the region B-1 and to the region B-2 are not much different, that is, the regions B-1 and B-2 have similar ranges of view, the same refractivity and eccentricity may be applied to the regions B-1 and B-2.

As described above, since the rear vision mirror according to the second embodiment of the present invention in the form of the aspheric progressive minor has a wide range of view, size of the rear vision mirror as a room mirror can be reduced compared to a conventional room mirror. As a result, the driver's front view would be less interfered with by the room mirror according to the second embodiment. Especially, since refracting surfaces are formed on the progressive mirror unit 50 according to variation of the refractivities, the headlights from vehicles behind can be distributed to the respective refracting surfaces, thereby effectively reducing the driver's dazzling during the night driving.

Although the minor unit 50 according to the first and second embodiments comprises three or five regions, these are only by way of example but the present invention is not limited to the embodiments.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A rear vision mirror for a vehicle, comprising:
a mirror unit in the form of an aspheric progressive surface mirror sectioned in a horizontal direction into at least three aspheric progressive regions having respectively different refractivities and eccentricities; and
a main body unit mounted to a vehicle body, while supporting the mirror unit,
wherein the refractivity and eccentricity of the sectioned region of the mirror unit are gradually increased from an inner region toward an outer region in a manner that, more specifically, refractivity of the inner region is gradually increased from the middle thereof toward a border with a middle region until being equalized to that of the middle region, and refractivity of the middle region is gradually increased from the middle thereof toward a border with the outer region until being equalized to that of the outer region.

2. The rear vision mirror according to claim 1, wherein the inner region has eccentricity of 0.1˜0.2 and refractivity of OD to the middle thereof with respect to the horizontal direction,
the middle region has eccentricity of 0.2˜0.3 and refractivity of +0.25 D to the horizontal middle, and
the outer region has eccentricity of 0.4 and refractivity of +0.5 D.

3. The rear vision mirror according to claim 1, wherein the inner region and the middle region are further sectioned each to upper and lower regions, so that the lower inner region has a greater eccentricity than the upper inner region and the lower middle region has a greater refractivity than the upper middle region, and
the refractivity of the upper middle region is gradually increased from the middle with respect to a vertical direction to a border with the lower middle region until being equalized to that of the lower middle region.

4. The rear vision mirror according to claim 3, wherein the lower inner region has eccentricity of 0.2˜0.3 and refractivity of +0.5 D.

5. The rear vision mirror according to claim 1, wherein horizontal widths of the inner, middle and outer regions are in the ratio of 4:3:3, and the mirror unit is applied to a side mirror of the vehicle.

6. The rear vision mirror according to claim 3, wherein vertical widths of the upper and the lower regions of the inner region and the middle region are in the ratio of 4:1.
